(19) United States
(12) Patent Application Publication
(10) Pub. No.: US 2026/0089640 A1
(43) Pub. Date: Mar. 26, 2026

(54) CELL GROUP BASED LOW POWER-WAKEUP SIGNALS FOR CARRIER AGGREGATION

(71) Applicant: QUALCOMM Incorporated, San Diego, CA (US)

(72) Inventors: Huilin XU, Beijing (CN); Kazuki TAKEDA, Minato-ku (JP); Shijun WU, San Diego, CA (US)

(21) Appl. No.: 19/338,743

(22) Filed: Sep. 24, 2025

Related U.S. Application Data
(60) Provisional application No. 63/699,786, filed on Sep. 26, 2024.

(51) Int. Cl. H04W 52/02; H04L 1/1607; H04W 36/00; H04W 72/23

(52) U.S. Cl. CPC H04W 52/0235; H04L 1/1614; H04W 36/00692; H04W 72/23

(57) ABSTRACT

Methods, systems, and devices for wireless communications are described. A user equipment (UE) may receive control information indicating a carrier aggregation configuration associated with a plurality of serving cells and indicating one or more groupings of serving cells configured for the UE. Each grouping of serving cells may include a set of serving cells from the plurality of serving cells. The UE may subsequently receive a low power-wakeup signal (LP-WUS) via a low power-wakeup radio and, at a location of the LP-WUS that is configured for the UE, the LP-WUS may include an indication of at least one grouping of serving cells, of the groupings of serving cells configured for the UE, on which the UE is to monitor physical downlink control channel (PDCCH). The UE may, thereafter, use its main radio to monitor PDCCH on one or more serving cells of the at least one grouping of serving cells.

### CROSS REFERENCES

The present Application for Patent claims benefit of U.S. Provisional Ser. No. 63/699,786 by XU et al., entitled “CELL GROUP BASED LOW POWER-WAKEUP SIGNALS FOR CARRIER AGGREGATION,” filed Sep. 26, 2024, assigned to the assignee hereof, and expressly incorporated herein.

### FIELD OF TECHNOLOGY

The following relates to wireless communications, including cell group based low power-wakeup signals (LP-WUSs) for carrier aggregation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control information indicating a carrier aggregation configuration associated with a set of multiple serving cells for the UE, receiving second control information indicating one or more groupings of serving cells configured for the UE, where each grouping of serving cells of the one or more groupings of serving cells includes a set of serving cells from among the set of multiple serving cells, receiving, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor physical downlink control channel (PDCCH), and monitoring, using a second radio of the UE and based on receiving the LP-WUS, the PDCCH on one or more serving cells of the at least one grouping of serving cells.

A UE for wireless communications is described. The UE may include one or more memories storing processor executable code, and one or more processors coupled with the one or more memories. The one or more processors may individually or collectively be operable to execute the code to cause the UE to receive first control information indicating a carrier aggregation configuration associated with a set of multiple serving cells for the UE, receive second control information indicating one or more groupings of serving cells configured for the UE, where each grouping of serving cells of the one or more groupings of serving cells includes a set of serving cells from among the set of multiple serving cells, receive, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor PDCCH, and monitor, using a second radio of the UE and based on receiving the LP-WUS, the PDCCH on one or more serving cells of the at least one grouping of serving cells.

Another UE for wireless communications is described. The UE may include means for receiving first control information indicating a carrier aggregation configuration associated with a set of multiple serving cells for the UE, means for receiving second control information indicating one or more groupings of serving cells configured for the UE, where each grouping of serving cells of the one or more groupings of serving cells includes a set of serving cells from among the set of multiple serving cells, means for receiving, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor PDCCH, and means for monitoring, using a second radio of the UE and based on receiving the LP-WUS, the PDCCH on one or more serving cells of the at least one grouping of serving cells.

A non-transitory computer-readable medium storing code for wireless communications is described. The code may include instructions executable by one or more processors to receive first control information indicating a carrier aggregation configuration associated with a set of multiple serving cells for the UE, receive second control information indicating one or more groupings of serving cells configured for the UE, where each grouping of serving cells of the one or more groupings of serving cells includes a set of serving cells from among the set of multiple serving cells, receive, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor PDCCH, and monitor, using a second radio of the UE and based on receiving the LP-WUS, the PDCCH on one or more serving cells of the at least one grouping of serving cells.

In some examples of the method, UEs, and non-transitory computer-readable medium described herein, receiving the LP-WUS that includes the indication of the at least one grouping of serving cells may include operations, features, means, or instructions for receiving the LP-WUS that includes one or more codepoints including the indication of the at least one grouping of serving cells.

Some examples of the method, UEs, and non-transitory computer-readable medium described herein may further include operations, features, means, or instructions for receiving third control information indicating the configured location and a quantity of consecutive codepoints assigned to the UE, where the configured location includes a configured first codepoint location, of the consecutive codepoints, that may be assigned to the UE as a start of the indication of the at least one grouping of serving cells on which the UE may be to monitor PDCCH and decoding each of the consecutive codepoints, beginning at the configured first codepoint location, to identify the at least one grouping of serving cells on which the UE may be to monitor PDCCH.

In some examples of the method, UEs, and non-transitory computer-readable medium described herein, each codepoint of the consecutive codepoints includes a codepoint value that may be associated with a respective grouping of serving cells of the at least one grouping of serving cells on which the UE may be to monitor PDCCH.

Some examples of the method, UEs, and non-transitory computer-readable medium described herein may further include operations, features, means, or instructions for receiving third control information indicating the configured location and a set of multiple consecutive monitoring occasions, during the first LP-WUS occasion, for receiving a set of multiple respective LP-WUSs, where the configured location includes a configured first monitoring occasion location, of the set of multiple consecutive monitoring occasions, that may be assigned to the UE as including the indication of the at least one grouping of serving cells on which the UE may be to monitor PDCCH, where receiving the LP-WUS includes receiving, during a first monitoring occasion of the set of multiple consecutive monitoring occasions, a first LP-WUS that includes a first codepoint, located at the configured first monitoring occasion location, including an indication of a first grouping of serving cells of the at least one grouping of serving cells, and where the method further includes decoding the first codepoint to identify the first grouping of serving cells on which the UE may be to monitor PDCCH.

Some examples of the method, UEs, and non-transitory computer-readable medium described herein may further include operations, features, means, or instructions for receiving, during a second monitoring occasion of the set of multiple consecutive monitoring occasions, a second LP-WUS that includes a second codepoint, including an indication of a second grouping of serving cells of the at least one grouping of serving cells and decoding the second codepoint to identify the second grouping of serving cells on which the UE may be to monitor PDCCH.

In some examples of the method, UEs, and non-transitory computer-readable medium described herein, receiving the LP-WUS that includes the indication of the at least one grouping of serving cells may include operations, features, means, or instructions for receiving the LP-WUS that includes a bitmap including the indication of the at least one grouping of serving cells.

Some examples of the method, UEs, and non-transitory computer-readable medium described herein may further include operations, features, means, or instructions for receiving third control information indicating the configured location, where the configured location includes a configured first bit location, within the bitmap, that may be assigned to the UE as a start of the indication of the at least one grouping of serving cells on which the UE may be to monitor PDCCH and decoding the bitmap, beginning at the configured first bit location, to identify the at least one grouping of serving cells on which the UE may be to monitor PDCCH.

In some examples of the method, UEs, and non-transitory computer-readable medium described herein, a quantity of consecutive bits of the bitmap, beginning at the configured first bit location, may be assigned to the UE, the quantity of consecutive bits may be equal to a quantity of the one or more groupings of serving cells configured for the UE, and each bit of the consecutive bits may be associated with a respective grouping of serving cells of the one or more groupings of serving cells configured for the UE.

In some examples of the method, UEs, and non-transitory computer-readable medium described herein, the LP-WUS may be shared among a set of multiple UEs and different first bit locations, within the bitmap, may be assigned to each of the set of multiple UEs.

Some examples of the method, UEs, and non-transitory computer-readable medium described herein may further include operations, features, means, or instructions for transmitting a message indicating a UE capability to support LP-WUS triggered PDCCH monitoring of indicated groupings of serving cells.

In some examples of the method, UEs, and non-transitory computer-readable medium described herein, each grouping of serving cells includes one or more secondary cells (SCells), a primary cell (PCell), or a combination thereof.

In some examples of the method, UEs, and non-transitory computer-readable medium described herein, the first radio includes a low power-wakeup radio (LP-WUR) and the second radio includes a main radio (MR).

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports cell group based low-power wakeup signals (LP-WUSs) for carrier aggregation in accordance with one or more aspects of the present disclosure.

FIG. 2 shows an example of a portion of a wireless communications system that supports cell group based LP-WUSs for carrier aggregation in accordance with one or more aspects of the present disclosure.

FIG. 3 shows an example of a signal design that supports cell group based LP-WUSs for carrier aggregation in accordance with one or more aspects of the present disclosure.

FIGS. 4 to 6 show examples of LP-WUS designs that support cell group based LP-WUSs for carrier aggregation in accordance with one or more aspects of the present disclosure.

FIG. 7 shows an example of a signal flow that supports cell group based LP-WUSs for carrier aggregation in accordance with one or more aspects of the present disclosure.

FIGS. 8 and 9 show block diagrams of devices that support cell group based LP-WUSs for carrier aggregation in accordance with one or more aspects of the present disclosure.

FIG. 10 shows a block diagram of a communications manager that supports cell group based LP-WUSs for carrier aggregation in accordance with one or more aspects of the present disclosure.

FIG. 11 shows a diagram of a system including a device that supports cell group based LP-WUSs for carrier aggregation in accordance with one or more aspects of the present disclosure.

FIGS. 12 through 14 show flowcharts illustrating methods that support cell group based LP-WUSs for carrier aggregation in accordance with one or more aspects of the present disclosure.

### DETAILED DESCRIPTION

Various aspects of the present disclosure relate to a wireless communication device, such as a user equipment (UE), that implements a low-power wakeup receiver (LP-WUR) architecture. The UE that implements the LP-WUR architecture may utilize a LP-WUR to monitor for and receive, from a network entity, such as a base station, one or more physical downlink control channel (PDCCH) messages to support wake up of a main radio (MR) at the UE when the UE operates in a low-power mode. For instance, some wireless communication systems may support the use of a LP-WUR at a UE as hardware configured for low-power wakeup signal (LP-WUS) monitoring. As compared to a conventional wireless transceiver (e.g., the MR), the LP-WUR may implement a simpler hardware design, resulting in lower operational power. Accordingly, use of such LP-WURs may substantially reduce overall power consumption at the UE.

In radio resource control (RRC) idle and inactive modes or in an RRC connected state where the UE is in a light or deep sleep, the UE may turn off the MR and switch to the LP-WUR to operate in a low-power mode in order to save power. In this low-power mode, the UE may use the LP-WUR to monitor for paging early indications (PEI), such as LP-WUSs, from a network entity that may serve as an indication of an upcoming PDCCH message (e.g., a paging PDCCH for RRC idle and inactive modes or a data scheduling PDCCH for RRC connected mode) intended for the UE. In this way, the UE may not need to continuously or unnecessarily perform PDCCH monitoring and decoding, which may consume more power than the detection of the LP-WUS, particularly in the cases of sporadic data scheduling.

Accordingly, when one or more data messages, such as one or more physical uplink or downlink shared channel (PxSCH) messages (e.g., PUSCH, PDSCH), need to be communicated to or from the UE, the UE may first receive an LP-WUS from the network entity and the LP-WUS may trigger the UE to wake up (e.g., to turn on) the MR to monitor for the PDCCH message. The PDCCH message (e.g., the data scheduling PDCCH for RRC connected mode) may, in turn, signal or schedule resources for communicating the one or more PxSCH messages. Although the PDCCH and upcoming PxSCH messages may be targeted to a specific UE, the LP-WUS may be designed as a group or sub-group common signal that triggers some or all of the UEs in a given group or sub-group to wake up. For instance, in some cases, the LP-WUS may provide an indication of one or more UEs being targeted for wakeup. In cases where the wireless communications system supports communications with a targeted UE using carrier aggregation, the LP-WUS may further need to support an indication of one or more groups of serving cells (e.g., a primary cell (PCell) or one or more secondary cells (SCells)) on which the targeted UE is to monitor PDCCH.

Aspects of the disclosure are initially described in the context of wireless communications systems. Aspects of the disclosure are further illustrated by and described with reference to apparatus diagrams, system diagrams, and flowcharts that relate to cell group based LP-WUSs for carrier aggregation.

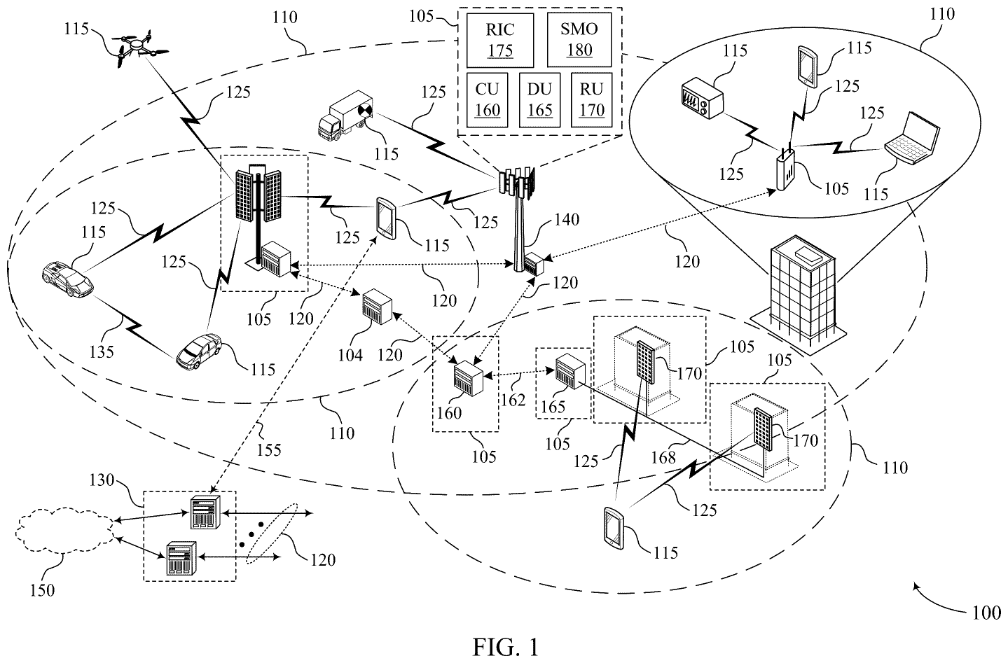

FIG. 1 shows an example of a wireless communications system 100 that supports cell group based LP-WUSs for carrier aggregation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support cell group based LP-WUSs for carrier aggregation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In accordance with aspects described herein, a UE 115 may be configured with a LP-WUR. The UE 115 may utilize the LP-WUR to monitor for and receive one or more signals when the UE 115 operates in a low-power mode. For example, the UE 115 may utilize the LP-WUR to monitor for and receive a LP-WUS transmitted by a network entity 105 and targeted for the UE 115. The LP-WUS may be indicative that the targeted UE 115 is to switch from use of the LP-WUR to a MR to receive a PDCCH and to additionally, or alternatively, communicate a PxSCH (e.g., a PDSCH or a PUSCH). In some cases, such as when the network entity 105 communicates with the targeted UE using carrier aggregation, the LP-WUS may provide an indication of one or more groups of serving cells (e.g., a PCell or one or more SCells) on which the targeted UE 115 is to monitor PDCCH.

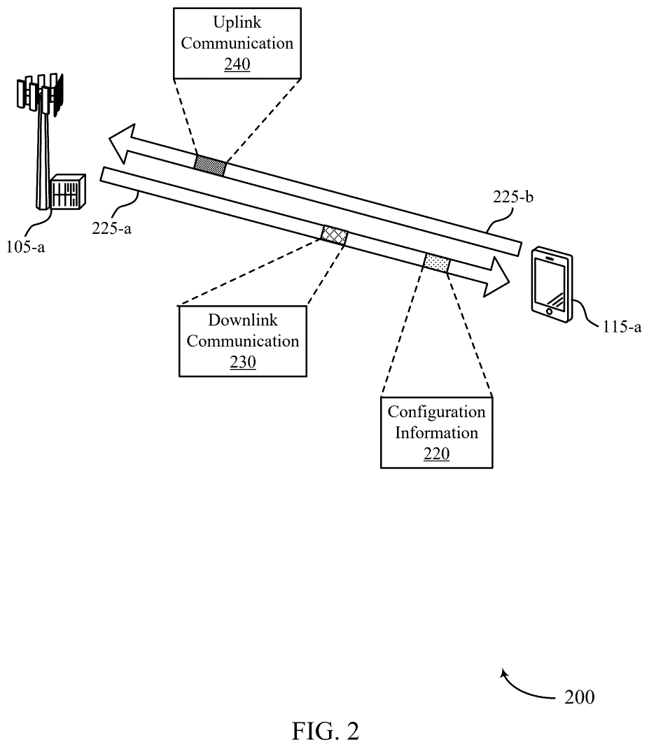

FIG. 2 shows an example of a portion of a wireless communications system 200 that supports cell group based LP-WUSs for carrier aggregation in accordance with one or more aspects of the present disclosure. In some cases, the wireless communications system 200 may support or be supported by aspects of the wireless communications system 100 described with reference to FIG. 1. For instance, the wireless communications system 200 may include a network entity 105-a and a UE 115-a, which may be examples of network entities 105 and UEs 115, respectively, described with reference to FIG. 1. The network entity 105-a and UE 115-a may communicate using communication links 225 (e.g., a Uu link), which may be examples of the communication link(s) 125 described with reference to FIG. 1.

For instance, the network entity 105-a may transmit, and the UE 115-a may receive downlink communications, such as a configuration information 220 or a downlink communication 230, via a downlink communication link 225-a. In accordance with aspects described herein, the configuration information 220 may include an indication of a carrier aggregation configuration associated with a plurality of serving cells. For example, the network entity 105-a may configure the UE 115-a to communicate using carrier aggregation, such as to combine multiple carriers or serving cells (e.g., a PCell and one or more SCells) to improve capacity and network performance. When the UE 115-a is configured for carrier aggregation, the configuration information may additionally indicate one or more groupings of the serving cells that are configured for the UE 115-a. Each of the groupings of serving cells may include a different subset (e.g., one or more) of the serving cells from among the plurality of serving cells. In some cases, the configuration information may additionally include an indication of one or more occasions for monitoring for a LP-WUS that signals an upcoming PDCCH control message for the UE 115-a. In some implementations, the downlink communication 230 may additionally include one or more LP-WUSs or one or more PDCCH control messages. The one or more LP-WUSs may be configured to cause the UE 115-a to wake up to monitor PDCCH on one or more grouping of serving cells for one or more upcoming control messages.

Additionally, the UE 115-a may transmit, and the network entity 105-a may receive, uplink communications, such as an uplink communication 240, via an uplink communication link 225-b. In some cases, the uplink communication 240 may be an uplink message scheduled on resources indicated by a received PDCCH control message.

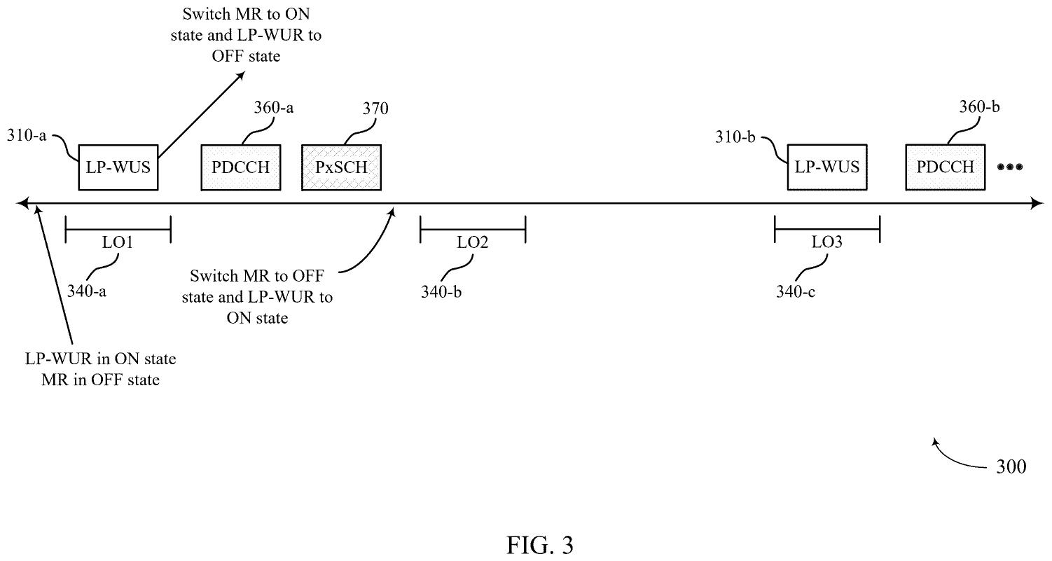

FIG. 3 shows an example of a signal design 300 that supports cell group based LP-WUSs for carrier aggregation in accordance with one or more aspects of the present disclosure. In some aspects, signal design 300 may be implemented by aspects of the wireless communications systems 100 and 200, as described with reference to FIGS. 1 and 2. For example, network entity 105-a, UE 115-a, or a combination thereof, may be configured to operate in accordance with the signal design 300. In some aspects, the UE 115-a may be configured with a LP-WUR, and the signal design 300 may support the use of the LP-WUR at the UE 115-a as the hardware for LP-WUS monitoring. The LP-WUR may implement a lower-complexity hardware design relative to that of a MR operating at the UE 115-a, resulting in reduced power consumption at the UE 115-a.

In some implementations, the UE 115-a may operate in a low power mode with its MR in an OFF state and with its LP-WUR in an ON state. The UE may use the LP-WUR to monitor one or more LP-WUS occasions 340 (e.g., a first LP-WUS occasions 340-a, a second LP-WUS occasion 340-b, a third LP-WUS occasion 340-c, and so forth) for one or more LP-WUSs 310. The network entity 105-a may transmit to the UE 115-a, during one or more of the LP-WUS occasions 340, one or more LP-WUSs 310 (e.g., a first LP-WUS 310-a and a second LP-WUS 310-b).

Reception of the LP-WUS 310 may trigger the UE 115-a to wake up, such as to switch its LP-WUR to an OFF state and switch its MR to an ON state to monitor for one or more upcoming PDCCH control messages 360 (e.g., a first PDCCH control message 360-a, a second PDCCH control message 360-b, etc.). Accordingly, the UE 115-a may receive and decode a LP-WUS 310, such as the first LP-WUS 310-a, to determine whether the LP-WUS 310 is intended for the UE 115-a. For instance, in some cases, the LP-WUS 310 may be intended for a different UE, such as a UE in a same group or sub-group as the UE 115-a. In some cases, the UE 115-a may determine whether the LP-WUS 310 is intended for the UE 115-a based on whether the LP-WUS includes an indication, at a location of the LP-WUS that is assigned for the UE 115-a, of one or more groupings of serving cells on which the UE 115-a is to monitor PDCCH. For instance, if the LP-WUS 310 does not include the indication of the one or more groupings of serving cells at the assigned location of the LP-WUS 310 for the UE 115-a, the LP-WUS 310 may not be intended for the UE 115-a. Otherwise, if the indication is provided at the assigned location, the UE 115-a may determine one or more groupings of serving cells on which to monitor PDCCH. The UE 115-a may then monitor PDCCH on the one or more groupings of serving cells indicated by the LP-WUS 310 to receive a PDCCH control message. In some cases, the control message may schedule resources for one or more upcoming messages to be transmitted to or from the UE 115-a, such as a PxSCH (e.g., PDSCH or PUSCH) message 370. In some cases, after the one or more messages (e.g., the PxSCH message 370) are transmitted, the UE 115-a may return to a low power state by turning its MR to an OFF state and returning the LP-WUR to an ON state.

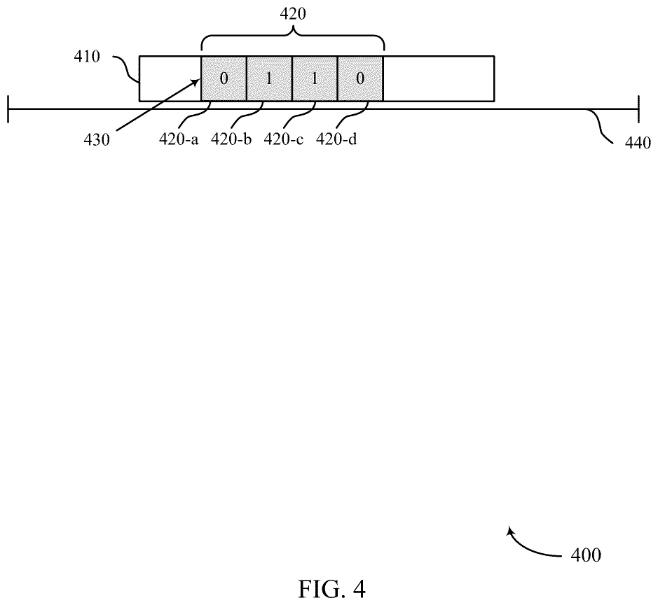

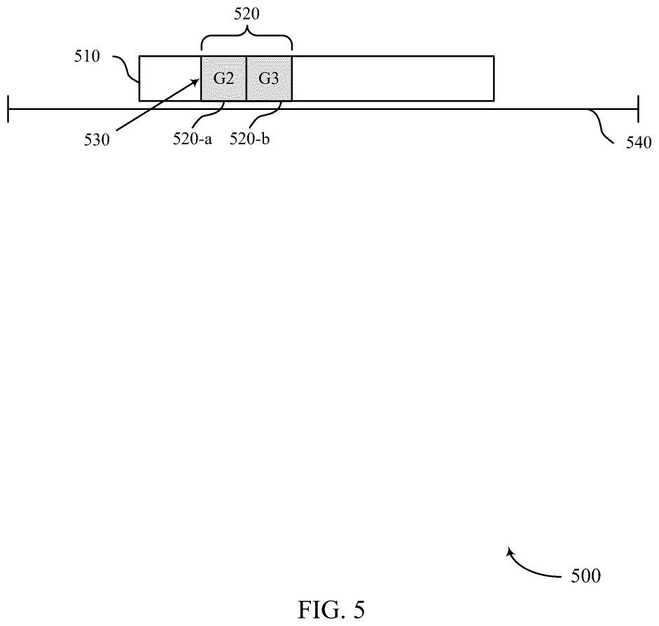

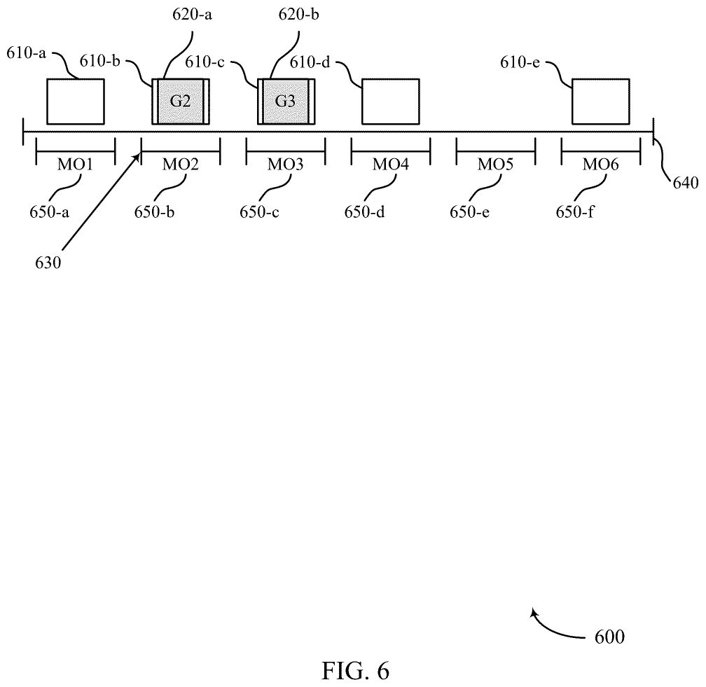

In some cases, the network entity 105-a may configure the LP-WUS 310 in accordance with a bitmap-based design, as described in further detail with respect to FIG. 4. In other cases, the network entity 105-a may configure the LP-WUS 310 in accordance with a codepoint-based design, as described in further detail with respect to FIGS. 5 and 6. The network entity 105-a may indicate to the UE 115-a, such as via the configuration information, a configuration associated with the LP-WUS 310.

FIG. 4 shows an example of a LP-WUS design 400 that supports cell group based LP-WUSs for carrier aggregation in accordance with one or more aspects of the present disclosure. In some aspects, LP-WUS design 400 may be implemented by aspects of the wireless communications systems 100 and 200 or the signal design 300, as described with reference to FIGS. 1 to 3. For example, the network entity 105-a, the UE 115-a, or a combination thereof, may be configured to operate in accordance with the LP-WUS design 400 for a LP-WUS 410 received during a LP-WUS occasion 440. The LP-WUS 410 and the LP-WUS occasion 440 may be examples of the first LP-WUS 310-a and the first LP-WUS occasion 340-a, respectively, of FIG. 3.

In some implementations, the network entity 105-a may configure the LP-WUS 410 in accordance with a bitmap-based design. In such cases, the LP-WUS 410 may include a bitmap 420 that includes one or more bits that provide the indication of the groupings of serving cells on which the UE 115-a is to monitor PDCCH. For instance, each of the one or more bits may be associated with a different grouping of serving cells configured for the UE 115-a. For example, a first bit 420-a may be associated with a first grouping of serving cells configured for the UE 115-a, a second bit 420-b may be associated with a second grouping of serving cells configured for the UE 115-a, a third bit 420-c may be associated with a third grouping of serving cells configured for the UE 115-a, and a fourth bit 420-d may be associated with a fourth grouping of serving cells configured for the UE 115-a.

The network entity 105-a may indicate which groupings of serving cells on which the UE 115-a should monitor PDCCH by setting a value of the corresponding bit to either 0 or 1. For instance, in some cases, a bit value of 1 (or alternatively a bit value of 0) may indicate that the UE 115-a is to monitor PDCCH on the corresponding grouping of serving cells. In this example, since the second bit 420-b and the third bit 420-c are set to a bit value of 1, the UE 115-a may determine that PDCCH on the second grouping of serving cells and on the third grouping of serving cells is to be monitored.

In some cases, multiple UEs may share the LP-WUS 410. In such cases, the network entity 105-a may configure certain locations of the bitmap 420 that correspond to different UEs'indications of groupings of serving cells to be monitored. For instance, the network entity 105-a may assign or configure (such as via the RRC configuration information) a starting (e.g., a first) bit location 430 of the bitmap 420 for each UE that shares the LP-WUS 410 (e.g., each UE may be configured with a different starting bit location). A quantity of consecutive bits from the configured starting bit location 430 may be assigned to the UE 115-a for providing the indication of the one or more groupings of serving cells to be monitored by the UE 115-a. In such cases, the quantity of the consecutive bits assigned to the UE 115-a may correspond to the quantity of groupings of serving cells that are configured for the UE 115-a. For example, if 4 groupings of serving cells are configured for the UE 115-a, the quantity of consecutive bits may be 4 and each of the 4 bits may be associated with a respective one of the 4 groupings of serving cells configured for the UE 115-a. Accordingly, the UE 115-a may decode the bitmap 420 starting at the configured starting bit location 430 to identify the one or more groupings of serving cells on which the UE 115-a is to monitor PDCCH. The UE 115-a may, thereafter, turn on its MR and monitor PDCCH at the indicated one or more groupings of serving cells. If the UE 115-a determines that no groupings of serving cells are indicated at the configured starting bit location 430, the UE 115-a may determine that the LP-WUS 410 is not intended for the UE 115-a and the UE 115-a may not turn on its MR and may not monitor PDCCH.

FIG. 5 shows an example of a LP-WUS design 500 that supports cell group based LP-WUSs for carrier aggregation in accordance with one or more aspects of the present disclosure. In some aspects, LP-WUS design 500 may be implemented by aspects of the wireless communications systems 100 and 200 or the signal design 300, as described with reference to FIGS. 1 to 3. For example, the network entity 105-a, the UE 115-a, or a combination thereof, may be configured to operate in accordance with the LP-WUS design 500 for a LP-WUS 510 received during a LP-WUS occasion 540. The LP-WUS 510 and the LP-WUS occasion 540 may be examples of the first LP-WUS 310-a and the first LP-WUS occasion 340-a, respectively, of FIG. 3.

In some implementations, the network entity 105-a may configure the LP-WUS 510 in accordance with a codepoint-based design. In some cases, the LP-WUS 510 may include one or more codepoints 520 that provide the indication of the groupings of serving cells on which the UE 115-a is to monitor PDCCH. For instance, each codepoint may indicate a codepoint value that is associated with one of the groupings of serving cells configured for the UE 115-a.

The network entity 105-a may indicate which groupings of serving cells the UE 115-a should monitor based on the codepoint value. For instance, each codepoint value may indicate a particular grouping of serving cells, from among the one of the groupings of serving cells configured for the UE 115-a, on which the UE 115-a is to monitor PDCCH. In this example, the LP-WUS 510 may include a first codepoint 520-a and a second codepoint 520-b indicting the groupings of serving cells on which the UE 115-a is to monitor PDCCH. For example, the first codepoint 520-a may indicate a codepoint value of “G2” that corresponds to the second grouping of serving cells and the second codepoint 520-b may indicate a codepoint value of “G3” that corresponds to the third grouping of serving cells.

In some cases, multiple UEs may share the LP-WUS 510. In such cases, the network entity 105-a may configure at least some locations of the LP-WUS 510 that correspond to different UEs'indications of groupings of serving cells to be monitored. For instance, the network entity 105-a may assign or configure (such as via the RRC configuration information) a starting (e.g., a first) codepoint location 530 for each UE that shares the LP-WUS 510 (e.g., each UE may be configured with a different starting codepoint location). A quantity of consecutive codepoints from the configured starting codepoint location 530 may be assigned to the UE 115-a for providing the indication of the one or more groupings of serving cells to be monitored by the UE 115-a. In such cases, the quantity of the consecutive codepoints assigned to the UE 115-a may correspond to the quantity of groupings of serving cells on which the UE 115-a is to monitor PDCCH. For example, four groupings of serving cells may be configured for the UE 115-a, however, only two groupings of serving cells may be configured for the UE 115-a to perform PDCCH monitoring. In this case, the quantity of consecutive codepoints assigned to the UE 115-a may be two and each of the two codepoints may be associated with a respective one of the two groupings of serving cells on which the UE 115-a is to monitor PDCCH. In another example, the quantity of consecutive codepoints assigned to the UE 115-a may be two and each of the two codepoints may be associated with a respective set of two groupings of the configured four groupings of serving cells on which the UE 115-a is to monitor PDCCH. In this case, each of the two codepoints may indicate a codepoint value for one grouping of the set of two groupings of serving cells that is associated with the codepoint. In a third example, the quantity of consecutive codepoints assigned to the UE 115-a may be two and each of the two codepoints may be associated with the configured four groupings of serving cells on which the UE 115-a is to monitor PDCCH. In this case, each of the two codepoints may indicate a codepoint value for one grouping of the four groupings of serving cells that is associated with the codepoint. Accordingly, the UE 115-a may decode the LP-WUS 510 starting at the configured starting codepoint location 530 to identify the up to two groupings of serving cells on which the UE 115-a is to monitor PDCCH. The UE 115-a may, thereafter, turn on its MR and monitor PDCCH at the indicated one or more groupings of serving cells. If the UE 115-a determines that no groupings of serving cells are indicated at the consecutive codepoints starting at the configured starting codepoint location 530 (e.g., if no energy is transmitted at the codepoint at the configured starting codepoint location 530), the UE 115-a may determine that the LP-WUS 510 is not intended for the UE 115-a and the UE 115-a may not turn on its MR and may not monitor PDCCH.

FIG. 6 shows an example of a LP-WUS design 600 that supports cell group based LP-WUSs for carrier aggregation in accordance with one or more aspects of the present disclosure. In some aspects, LP-WUS design 600 may be implemented by aspects of the wireless communications systems 100 and 200 or the signal design 300, as described with reference to FIGS. 1 to 3. For example, the network entity 105-a, the UE 115-a, or a combination thereof, may be configured to operate in accordance with the LP-WUS design 600 for LP-WUSs 610 (e.g., a first LP-WUSs 610-a, a second LP-WUSs 610-b, a third LP-WUSs 610-c, a fourth LP-WUSs 610-d, and a fifth LP-WUSs 610-e) received during one or more monitoring occasions 650 (e.g., a first monitoring occasion 650-a, a second monitoring occasion 650-b, a third monitoring occasion 650-c, a fourth monitoring occasion 650-d, a fifth monitoring occasion 650-e, and a sixth monitoring occasion 650-f) of a LP-WUS occasion 640. The LP-WUSs 610 and the LP-WUS occasion 640 may be examples of the first LP-WUS 310-a and the first LP-WUS occasion 340-a, respectively, of FIG. 3.

In some implementations, the network entity 105-a may configure the LP-WUS 610 in accordance with a codepoint-based design. In some cases, one or more of the LP-WUSs 610 may include a single codepoint 620 that provides the indication of the groupings of serving cells on which the UE 115-a is to monitor PDCCH. For instance, during a single LP-WUS occasion 640, the network entity 105-a may transmit multiple LP-WUSs 610, each in a separate respective monitoring occasion 650, and one or more of the LP-WUSs 610 may indicate a codepoint value that is associated with one of the groupings of serving cells configured for the UE 115-a.

The network entity 105-a may indicate which groupings of serving cells the UE 115-a should monitor based on the codepoint value. For instance, each codepoint value may indicate a particular grouping of serving cells, from among the one of the groupings of serving cells configured for the UE 115-a, on which the UE 115-a is to monitor PDCCH. In this example, the second LP-WUS 610-b received during the second monitoring occasion 650-b may include a first codepoint 620-a and the third LP-WUS 610-c received during the third monitoring occasion 650-c may include a second codepoint 620-b; and the first codepoint 620-a and the second codepoint 620-b may indicate the groupings of serving cells on which the UE 115-a is to monitor PDCCH. For example, the first codepoint 620-a may indicate a codepoint value of “G2” that corresponds to the second grouping of serving cells and the second codepoint 620-b may indicate a codepoint value of “G3” that corresponds to the third grouping of serving cells.

In some cases, multiple UEs may share one or more of monitoring occasions 650 for receiving the LP-WUSs 610. In such cases, the network entity 105-a may configure different monitoring occasions 650 that correspond to different UEs'indications of groupings of serving cells to be monitored. For instance, the network entity 105-a may assign or configure (such as via the RRC configuration information) a starting (e.g., a first) monitoring occasion 630 for each UE that shares the monitoring occasions 630 for receiving LP-WUSs 610 (e.g., each UE may be configured with a different starting monitoring occasion). A quantity of consecutive monitoring occasions from the configured starting monitoring occasion 630 may be assigned to the UE 115-a for providing the indication of the one or more groupings of serving cells to be monitored by the UE 115-a. In such cases, the quantity of the consecutive monitoring occasions assigned to the UE 115-a may correspond to the quantity of groupings of serving cells on which the UE 115-a is to monitor PDCCH. For example, four groupings of serving cells may be configured for the UE 115-a, however, only two groupings may be configured for the UE 115-a to perform PDCCH monitoring. In this case, the quantity of consecutive monitoring occasions 650 assigned to the UE 115-a for transmitting separate LP-WUSs 610 each carrying a single codepoint may be two. In this case, the network entity 105-a may transmit two separate LP-WUSs 610 during the two consecutive monitoring occasions 650 starting at the configured starting monitoring occasion 630 and each of the two separate codepoints may be associated with a respective one of the two groupings of serving cells on which the UE 115-a is to monitor PDCCH. In another example, the quantity of consecutive monitoring occasions 650 assigned to the UE 115-a may be two and each of the two codepoints may be associated with a respective set of two groupings of the configured four groupings of serving cells on which the UE 115-a is to monitor PDCCH. In this case, each of the two codepoints may indicate a codepoint value for one grouping of the set of two groupings of serving cells that is associated with the codepoint. In a third example, the quantity of consecutive monitoring occasions 650 assigned to the UE 115-a may be two and each of the two codepoints may be associated with the configured four groupings of serving cells on which the UE 115-a is to monitor PDCCH. In this case, each of the two codepoints may indicate a codepoint value for one grouping of the four groupings of serving cells that is associated with the codepoint.

Accordingly, the UE 115-a may decode the LP-WUS 610-a received during the configured starting monitoring occasion 630 and may additionally decode the LP-WUSs 610 received during the quantity of consecutive monitoring occasions to identify the up to two groupings of serving cells on which the UE 115-a is to monitor PDCCH. The UE 115-a may, thereafter, turn on its MR and monitor PDCCH at the indicated one or more groupings of serving cells. If the UE 115-a determines that no groupings of serving cells are indicated by the LP-WUS 610 at the consecutive monitoring occasion 650 starting at the configured starting monitoring occasion 630 (e.g., or if no LP-WUS 610 is transmitted at the configured starting monitoring occasion 630), the UE 115-a may determine that the LP-WUS 610 (or an upcoming PDCCH message) is not intended for the UE 115-a and the UE 115-a may not turn on its MR and may not monitor PDCCH.

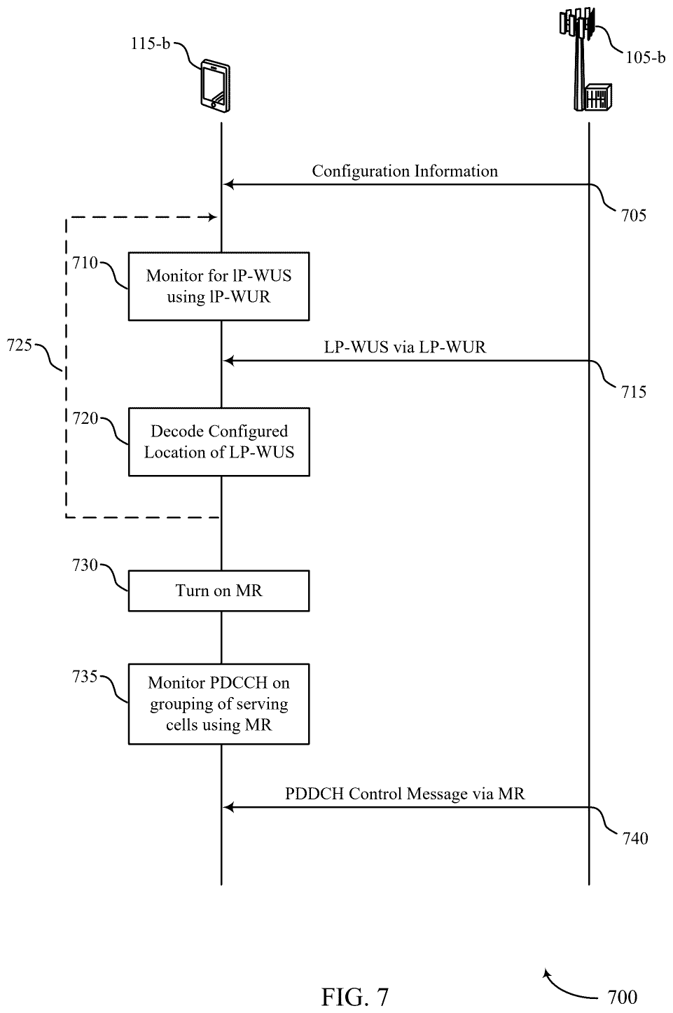

FIG. 7 shows an example of a signal flow 700 that supports cell group based LP-WUSs for carrier aggregation in accordance with one or more aspects of the present disclosure. In some aspects, the signal flow 700 may implement or be implemented by aspects of the wireless communications systems 100 and 200, signal design 300, and LP-WUS designs 400, 500, and 600 as described with reference to FIGS. 1 to 6. The signal flow 700 may illustrate the flow of signals between the UE 115-b and the network entity 105-b. In the following description of the signal flow 700, the communications between the UE 115-b and the network entity 105-b may be transmitted in a different order than the order shown, or the operations performed by the UE 115-b and the network entity 105-b may be performed in different orders or at different times. Some operations may also be omitted from the signal flow 700, and other operations may be added to the signal flow 700. In some aspects, the operations illustrated in signal flow 700 may be performed by hardware (e.g., including circuitry, processing blocks, logic components, and other components), code (e.g., software or firmware) executed by a processor, or any combination thereof. Alternatively, some steps may be performed in a different order than described or might not be performed at all. In some cases, steps may include additional features not mentioned below, or further steps may be added.

In some cases, the UE 115-b may turn off its main radio and switch to its LP-WUR to operate in a low-power mode in order to save power. The UE 115-b may use the LP-WUR to monitor for one or more LP-WUSs.

At 705, the network entity 105-b may transmit, and the UE 115-b may receive, configuration information that indicates a carrier aggregation configuration associated with a plurality of serving cells. The plurality of serving cells may be a PCell or one or more SCells. The configuration information may additionally indicate one or more groupings of serving cells that are configured for the UE 115-b. Each of the groupings of serving cells may include a different subset of the serving cells from among the plurality of serving cells. In some cases, a grouping of serving cells may include one or more deactivated serving cells. The configuration information may additionally include an indication of a location within an LP-WUS or a location of a LP-WUS monitoring occasion where the UE 115-b may locate an indication of one or more groupings of serving cells on which the UE 115-b is to monitor PDCCH. The configuration information may be transmitted by the network entity 105-b via RRC signaling. In some cases, the configuration information is transmitted in response to a message from the UE 115-b reporting a capability to support LP-WUSs that are based on groupings of serving cells.

At 710, the UE 115-b may use a LP-WUR to monitor, during a LP-WUS occasion, for one or more LP-WUSs. For instance, the network entity 105-b may pre-configure one or more occasions for receiving LP-WUSs, and the UE 115-b may monitor one or more of the LP-WUS occasions for the LP-WUS. The LP-WUS occasions may be signaled to the UE 115-b via RRC signaling. In some cases, the LP-WUS occasions may be signaled together with the configuration information.

At 715, the network entity 105-b may transmit, and the UE 115-b may receive, using the LP-WUR, a LP-WUS during one of the LP-WUS occasions. The LP-WUS may target the UE 115-b to wake up. That is, reception of the LP-WUS 310 may be an indication for the UE 115-a to begin to monitor PDCCH for one or more control messages. In some cases, the LP-WUS may include an indication of one or more groupings of serving cells on which the UE 115-b is to monitor PDCCH. In some cases, the LP-WUS may target a different UE to wake up. That is, in some cases, the LP-WUS may not be intended for the UE 115-b. For example, the LP-WUS may be intended for one or more other UEs in a same group or sub-group as the UE 115-b.

At 720, the UE 115-b may decode the LP-WUS to determine whether the LP-WUS is intended for the UE 115-b, and if so, to determine the one or more groupings of serving cells on which the UE 115-b should monitor PDCCH. For instance, the indication of the one or more groupings of serving cells on which the UE 115-b is to monitor PDCCH may be provided at a location of the LP-WUS that is assigned to the UE 115-b (such as provided in the configuration information). If the indication is not provided at the assigned location, the LP-WUS may not be intended for the UE 115-b. For instance, in some implementations, the LP-WUS may be a bitmap-based LP-WUS that includes a bitmap that includes, at a location assigned to the UE 115-b, a number of consecutive bits that carry the indication of the one or more groupings of serving cells on which the UE 115-b is to monitor PDCCH. In some implementations, the LP-WUS may be a codepoint-based LP-WUS that includes one or more codepoint values, at a location of the LP-WUS assigned to the UE 115-b or at a location of a monitoring occasion assigned to the 115-b, that indicate the one or more groupings of serving cells on which the UE 115-b is to monitor PDCCH. Accordingly, the UE 115-b may decode the LP-WUS, beginning at the assigned location for the UE 115-b, to determine the one or more groupings of serving cells on which the UE 115-b is to monitor PDCCH.

At 725, if the UE 115-b determines that the LP-WUS is not targeted to the UE 115-b, the UE 115-b may continue to monitor for further LP-WUSs using the LP-WUR.

At 730, if the UE 115-b determines that the LP-WUS is targeted to the UE 115-b, the UE 115-b may turn on its MR.

At 735, the UE 115-b may use its MR to begin monitoring PDCCH on the one or more groupings of serving cells indicated by the LP-WUS.

At 740, the network entity 105-b may transmit, and the UE 115-b may receive via the MR, a control message via the PDCCH on one of the one or more groupings of serving cells monitored by the UE 115-b.

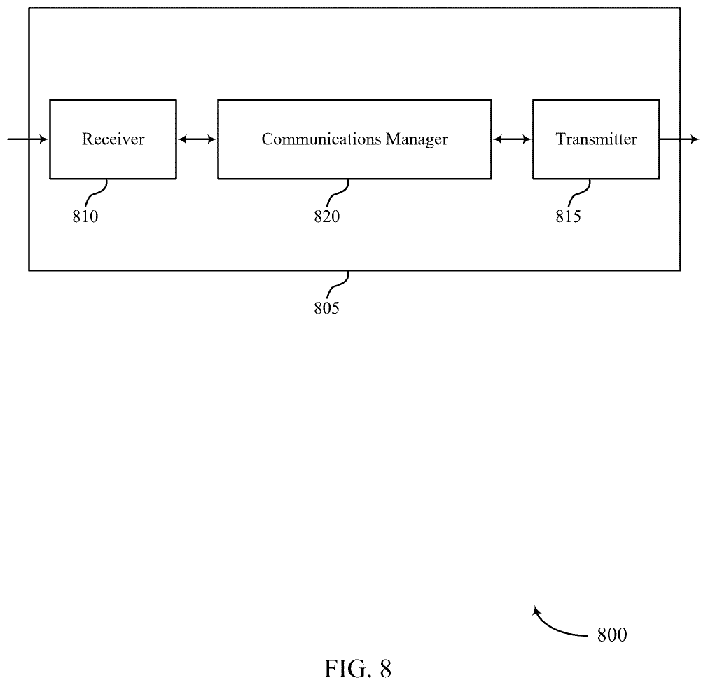

FIG. 8 shows a block diagram 800 of a device 805 that supports cell group based LP-WUSs for carrier aggregation in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques.

Each of these components may be in communication with one another (e.g., via one or more buses).

The receiver 810 may provide a means for receiving information such as packets, user data, control information, or any combination thereof associated with various information channels (e.g., control channels, data channels, information channels related to cell group based LP-WUSs for carrier aggregation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to cell group based LP-WUSs for carrier aggregation). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of cell group based LP-WUSs for carrier aggregation as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving first control information indicating a carrier aggregation configuration associated with a set of multiple serving cells for the UE. The communications manager 820 is capable of, configured to, or operable to support a means for receiving second control information indicating one or more groupings of serving cells configured for the UE, where each grouping of serving cells of the one or more groupings of serving cells includes a set of serving cells from among the set of multiple serving cells. The communications manager 820 is capable of, configured to, or operable to support a means for receiving, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor PDCCH. The communications manager 820 is capable of, configured to, or operable to support a means for monitoring, using a second radio of the UE and based on receiving the LP-WUS, the PDCCH on one or more serving cells of the at least one grouping of serving cells.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption and more efficient utilization of communication resources.

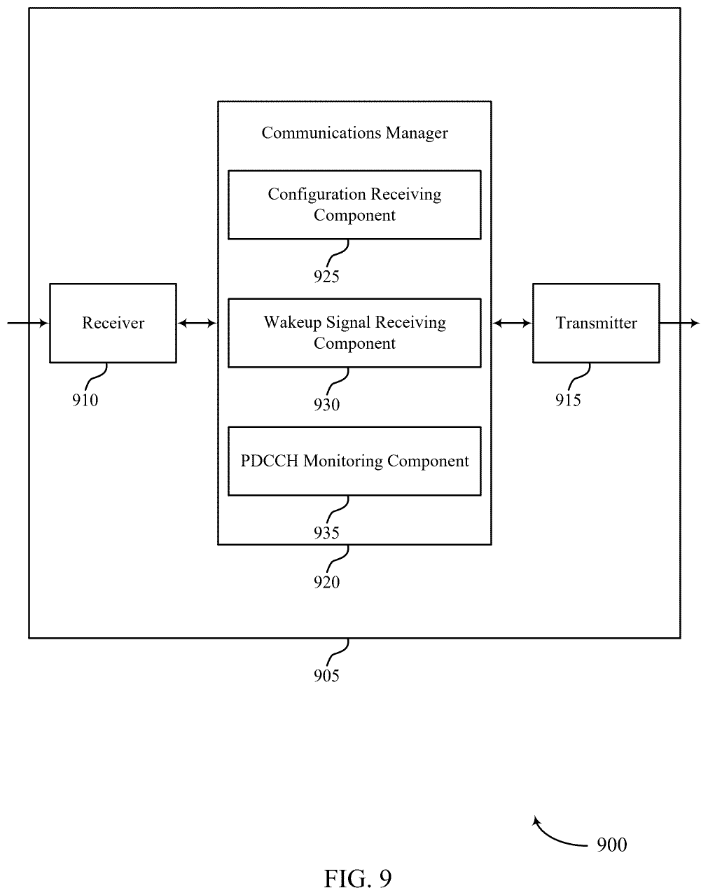

FIG. 9 shows a block diagram 900 of a device 905 that supports cell group based LP-WUSs for carrier aggregation in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to cell group based LP-WUSs for carrier aggregation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to cell group based LP-WUSs for carrier aggregation). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of cell group based LP-WUSs for carrier aggregation as described herein. For example, the communications manager 920 may include a configuration receiving component 925, a wakeup signal receiving component 930, a PDCCH monitoring component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The configuration receiving component 925 is capable of, configured to, or operable to support a means for receiving first control information indicating a carrier aggregation configuration associated with a set of multiple serving cells for the UE. The configuration receiving component 925 is capable of, configured to, or operable to support a means for receiving second control information indicating one or more groupings of serving cells configured for the UE, where each grouping of serving cells of the one or more groupings of serving cells includes a set of serving cells from among the set of multiple serving cells. The wakeup signal receiving component 930 is capable of, configured to, or operable to support a means for receiving, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor PDCCH. The PDCCH monitoring component 935 is capable of, configured to, or operable to support a means for monitoring, using a second radio of the UE and based on receiving the LP-WUS, the PDCCH on one or more serving cells of the at least one grouping of serving cells.

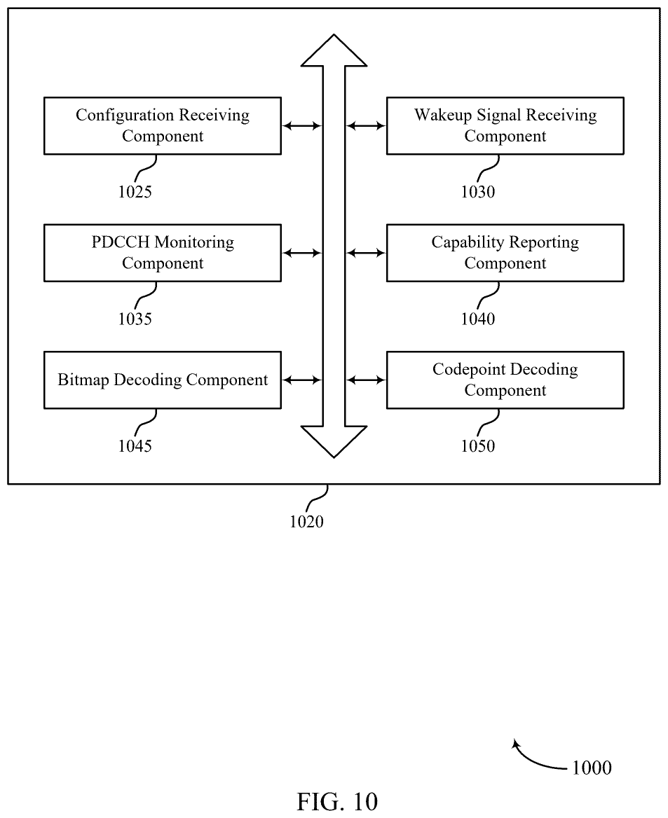

FIG. 10 shows a block diagram 1000 of a communications manager 1020 that supports cell group based LP-WUSs for carrier aggregation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of cell group based LP-WUSs for carrier aggregation as described herein. For example, the communications manager 1020 may include a configuration receiving component 1025, a wakeup signal receiving component 1030, a PDCCH monitoring component 1035, a capability reporting component 1040, a bitmap decoding component 1045, a codepoint decoding component 1050, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The configuration receiving component 1025 is capable of, configured to, or operable to support a means for receiving first control information indicating a carrier aggregation configuration associated with a set of multiple serving cells for the UE. In some examples, the configuration receiving component 1025 is capable of, configured to, or operable to support a means for receiving second control information indicating one or more groupings of serving cells configured for the UE, where each grouping of serving cells of the one or more groupings of serving cells includes a set of serving cells from among the set of multiple serving cells. The wakeup signal receiving component 1030 is capable of, configured to, or operable to support a means for receiving, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor PDCCH. The PDCCH monitoring component 1035 is capable of, configured to, or operable to support a means for monitoring, using a second radio of the UE and based on receiving the LP-WUS, the PDCCH on one or more serving cells of the at least one grouping of serving cells.

In some examples, to support receiving the LP-WUS that includes the indication of the at least one grouping of serving cells, the wakeup signal receiving component 1030 is capable of, configured to, or operable to support a means for receiving the LP-WUS that includes a bitmap including the indication of the at least one grouping of serving cells.

In some examples, the configuration receiving component 1025 is capable of, configured to, or operable to support a means for receiving third control information indicating the configured location, where the configured location includes a configured first bit location, within the bitmap, that is assigned to the UE as a start of the indication of the at least one grouping of serving cells on which the UE is to monitor PDCCH. In some examples, the bitmap decoding component 1045 is capable of, configured to, or operable to support a means for decoding the bitmap, beginning at the configured first bit location, to identify the at least one grouping of serving cells on which the UE is to monitor PDCCH.

In some examples, a quantity of consecutive bits of the bitmap, beginning at the configured first bit location, is assigned to the UE. In some examples, the quantity of consecutive bits is equal to a quantity of the one or more groupings of serving cells configured for the UE. In some examples, each bit of the consecutive bits is associated with a respective grouping of serving cells of the one or more groupings of serving cells configured for the UE.

In some examples, the LP-WUS is shared among a set of multiple UEs. In some examples, different first bit locations, within the bitmap, are assigned to each of the set of multiple UEs.

In some examples, to support receiving the LP-WUS that includes the indication of the at least one grouping of serving cells, the wakeup signal receiving component 1030 is capable of, configured to, or operable to support a means for receiving the LP-WUS that includes one or more codepoints including the indication of the at least one grouping of serving cells.

In some examples, the configuration receiving component 1025 is capable of, configured to, or operable to support a means for receiving third control information indicating the configured location and a quantity of consecutive codepoints assigned to the UE, where the configured location includes a configured first codepoint location, of the consecutive codepoints, that is assigned to the UE as a start of the indication of the at least one grouping of serving cells on which the UE is to monitor PDCCH. In some examples, the codepoint decoding component 1050 is capable of, configured to, or operable to support a means for decoding each of the consecutive codepoints, beginning at the configured first codepoint location, to identify the at least one grouping of serving cells on which the UE is to monitor PDCCH.

In some examples, each codepoint of the consecutive codepoints includes a codepoint value that is associated with a respective grouping of serving cells of the at least one grouping of serving cells on which the UE is to monitor PDCCH.

In some examples, the configuration receiving component 1025 is capable of, configured to, or operable to support a means for receiving third control information indicating the configured location and a set of multiple consecutive monitoring occasions, during the first LP-WUS occasion, for receiving a set of multiple respective LP-WUSs, where the configured location includes a configured first monitoring occasion location, of the set of multiple consecutive monitoring occasions, that is assigned to the UE as including the indication of the at least one grouping of serving cells on which the UE is to monitor PDCCH. In some examples, to support receiving the LP-WUS, the wakeup signal receiving component 1030 is capable of, configured to, or operable to support a means for receiving, during a first monitoring occasion of the set of multiple consecutive monitoring occasions, a first LP-WUS that includes a first codepoint, located at the configured first monitoring occasion location, including an indication of a first grouping of serving cells of the at least one grouping of serving cells. In some examples, the codepoint decoding component 1050 is capable of, configured to, or operable to support decoding the first codepoint to identify the first grouping of serving cells on which the UE is to monitor PDCCH.

In some examples, the wakeup signal receiving component 1030 is capable of, configured to, or operable to support a means for receiving, during a second monitoring occasion of the set of multiple consecutive monitoring occasions, a second LP-WUS that includes a second codepoint, including an indication of a second grouping of serving cells of the at least one grouping of serving cells. In some examples, the codepoint decoding component 1050 is capable of, configured to, or operable to support a means for decoding the second codepoint to identify the second grouping of serving cells on which the UE is to monitor PDCCH.

In some examples, the capability reporting component 1040 is capable of, configured to, or operable to support a means for transmitting a message indicating a UE capability to support LP-WUS triggered PDCCH monitoring of indicated groupings of serving cells.

In some examples, each grouping of serving cells includes one or more SCells, a PCell, or a combination thereof.

In some examples, the first radio includes a low power-wakeup radio (LP-WUR) and the second radio includes a MR.

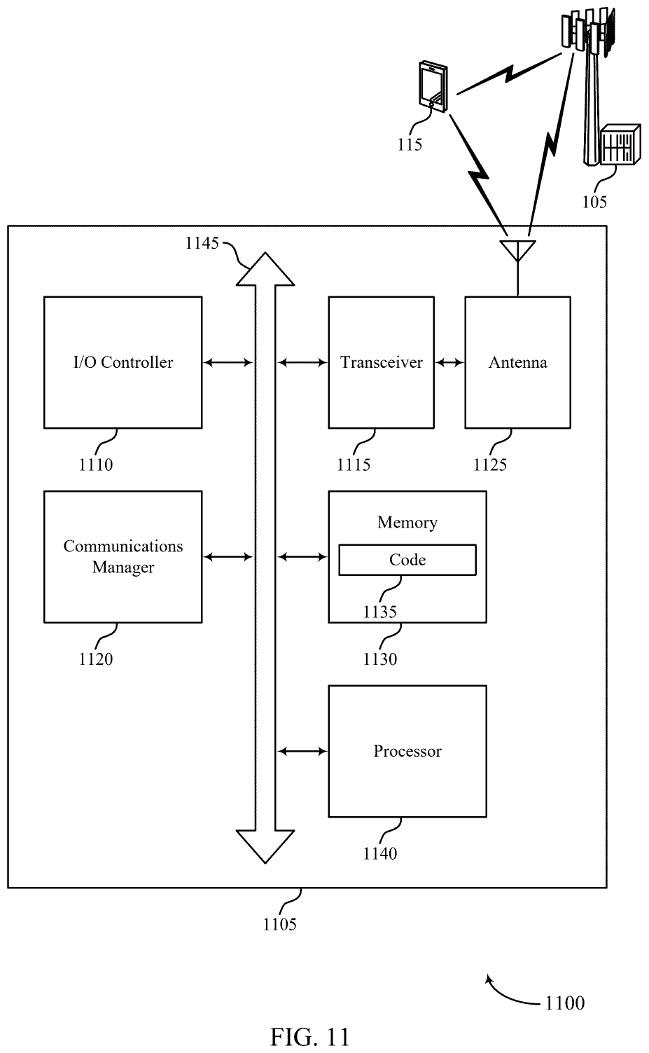

FIG. 11 shows a diagram of a system 1100 including a device 1105 that supports cell group based LP-WUSs for carrier aggregation in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting cell group based LP-WUSs for carrier aggregation). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving first control information indicating a carrier aggregation configuration associated with a set of multiple serving cells for the UE. The communications manager 1120 is capable of, configured to, or operable to support a means for receiving second control information indicating one or more groupings of serving cells configured for the UE, where each grouping of serving cells of the one or more groupings of serving cells includes a set of serving cells from among the set of multiple serving cells. The communications manager 1120 is capable of, configured to, or operable to support a means for receiving, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor PDCCH. The communications manager 1120 is capable of, configured to, or operable to support a means for monitoring, using a second radio of the UE and based on receiving the LP-WUS, the PDCCH on one or more serving cells of the at least one grouping of serving cells.

By including or configuring the communications manager 1120 in accordance with examples as described herein, the device 1105 may support techniques for reduced latency, improved user experience related to reduced processing, reduced power consumption, more efficient utilization of communication resources, and longer battery life.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of cell group based LP-WUSs for carrier aggregation as described herein, or the at least one processor 1140 and the at least one memory 1130 may be otherwise configured to, individually or collectively, perform or support such operations.

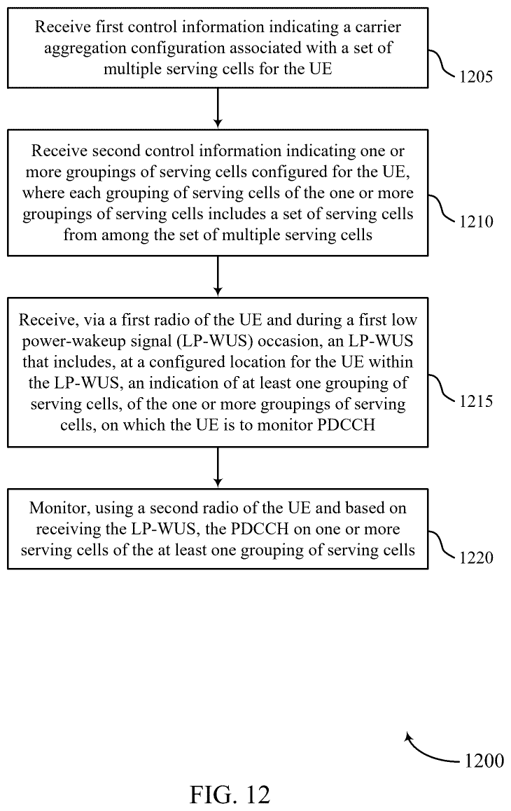

FIG. 12 shows a flowchart illustrating a method 1200 that supports cell group based LP-WUSs for carrier aggregation in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving first control information indicating a carrier aggregation configuration associated with a set of multiple serving cells for the UE. The operations of 1205 may be performed in accordance with examples as disclosed herein. In some examples, aspects of the operations of 1205 may be performed by a configuration receiving component 1025 as described with reference to FIG. 10.

At 1210, the method may include receiving second control information indicating one or more groupings of serving cells configured for the UE, where each grouping of serving cells of the one or more groupings of serving cells includes a set of serving cells from among the set of multiple serving cells. The operations of 1210 may be performed in accordance with examples as disclosed herein. In some examples, aspects of the operations of 1210 may be performed by a configuration receiving component 1025 as described with reference to FIG. 10.

At 1215, the method may include receiving, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor PDCCH. The operations of 1215 may be performed in accordance with examples as disclosed herein. In some examples, aspects of the operations of 1215 may be performed by a wakeup signal receiving component 1030 as described with reference to FIG. 10.

At 1220, the method may include monitoring, using a second radio of the UE and based on receiving the LP-WUS, the PDCCH on one or more serving cells of the at least one grouping of serving cells. The operations of 1220 may be performed in accordance with examples as disclosed herein. In some examples, aspects of the operations of 1220 may be performed by a PDCCH monitoring component 1035 as described with reference to FIG. 10.

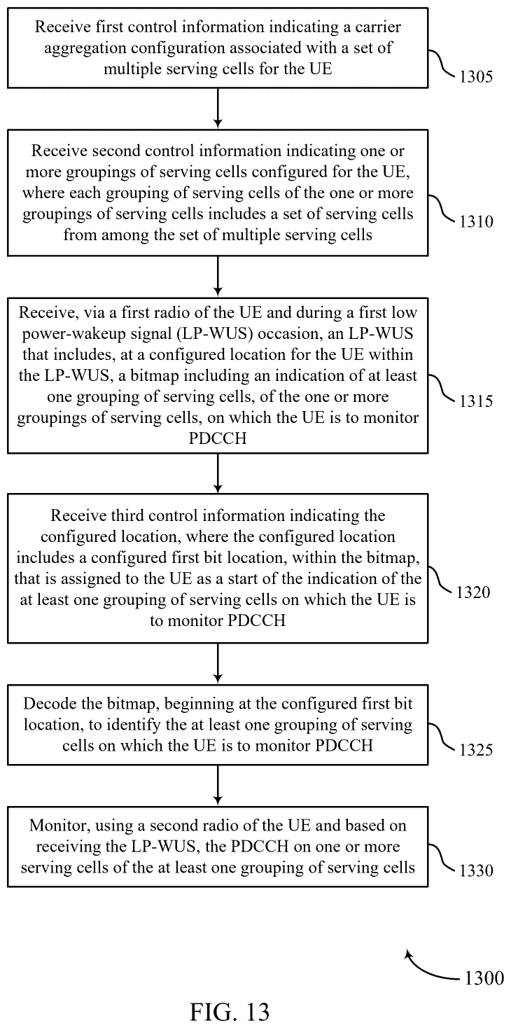

FIG. 13 shows a flowchart illustrating a method 1300 that supports cell group based LP-WUSs for carrier aggregation in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving first control information indicating a carrier aggregation configuration associated with a set of multiple serving cells for the UE. The operations of 1305 may be performed in accordance with examples as disclosed herein. In some examples, aspects of the operations of 1305 may be performed by a configuration receiving component 1025 as described with reference to FIG. 10.

At 1310, the method may include receiving second control information indicating one or more groupings of serving cells configured for the UE, where each grouping of serving cells of the one or more groupings of serving cells includes a set of serving cells from among the set of multiple serving cells. The operations of 1310 may be performed in accordance with examples as disclosed herein. In some examples, aspects of the operations of 1310 may be performed by a configuration receiving component 1025 as described with reference to FIG. 10.

At 1315, the method may include receiving, via a first radio of the UE and during a first LP-WUS occasion, an LP-WUS that includes, at a configured location for the UE within the LP-WUS, a bitmap including an indication of at least one grouping of serving cells, of the one or more groupings of serving cells, on which the UE is to monitor PDCCH. The operations of 1315 may be performed in accordance with examples as disclosed herein. In some examples, aspects of the operations of 1315 may be performed by a wakeup signal receiving component 1030 as described with reference to FIG. 10.

At 1320, the method may include receiving third control information indicating the configured location, where the configured location includes a configured first bit location, within the bitmap, that is assigned to the UE as a start of the indication of the at least one grouping of serving cells on which the UE is to monitor PDCCH. The operations of 1320 may be performed in accordance with examples as disclosed herein. In some examples, aspects of the operations of 1320 may be performed by a configuration receiving component 1025 as described with reference to FIG. 10.

At 1325 , the method may include decoding the bitmap, beginning at the configured first bit location, to identify the at least one grouping of serving cells on which the UE is to monitor PDCCH. The operations of 1325 may be performed in accordance with examples as disclosed herein. In some examples, aspects of the operations of 1325 may be performed by a bitmap decoding component 1045 as described with reference to FIG. 10.

At 1330 , the method may include monitoring, using a second radio of the UE and based on receiving the LP-WUS, the PDCCH on one or more serving cells of the at least one grouping of serving cells. The operations of 1330 may be performed in accordance with examples as disclosed herein. In some examples, aspects of the operations of 1330 may be performed by a PDCCH monitoring component 1035 as described with reference to FIG. 10.

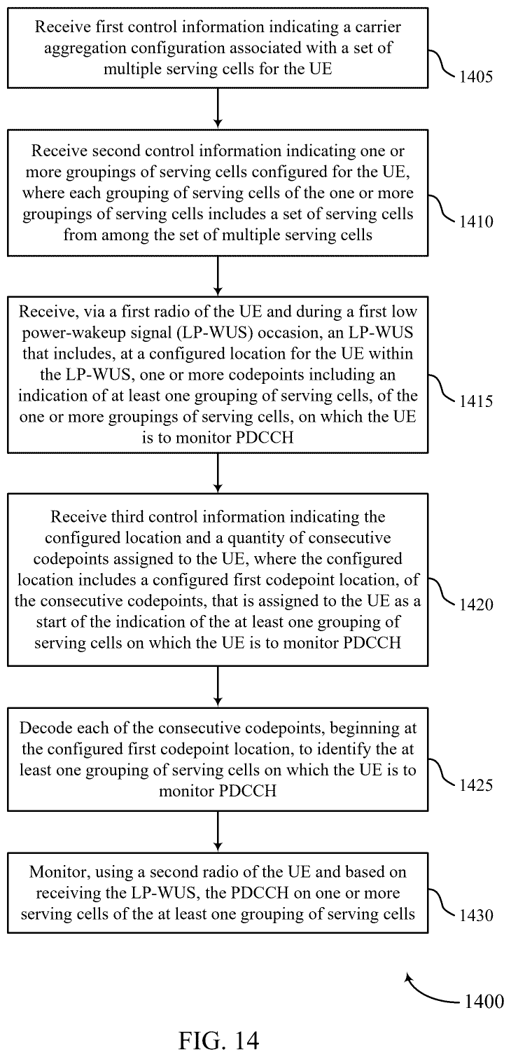

FIG. 14 shows a flowchart illustrating a method 1400 that supports cell group based LP-WUSs for carrier aggregation in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving first control information indicating a carrier aggregation configuration associated with a set of multiple serving cells for the UE. The operations of 1405 may be performed in accordance with examples as disclosed herein. In some examples, aspects of the operations of 1405 may be performed by a configuration receiving component 1025 as described with reference to FIG. 10.

At 1410, the method may include receiving second control information indicating one or more groupings of serving cells configured for the UE, where each grouping of serving cells of the one or more groupings of serving cells includes a set of serving cells from among the set of multiple serving cells. The operations of 1410 may be performed in accordance with examples as disclosed herein. In some examples, aspects of the operations of 1410 may be performed by a configuration receiving component 1025 as described with reference to FIG. 10.

At 1415, the method may include receiving, via a first radio of the UE and during a first LP-WUS occasion, an LP-WUS that includes, at a configured location for the UE within the LP-WUS, one or more codepoints including an indication of at least one grouping of serving cells, of the one or more groupings of serving cells, on which the UE is to monitor PDCCH. The operations of 1415 may be performed in accordance with examples as disclosed herein. In some examples, aspects of the operations of 1415 may be performed by a wakeup signal receiving component 1030 as described with reference to FIG. 10.

At 1420, the method may include receiving third control information indicating the configured location and a quantity of consecutive codepoints assigned to the UE, where the configured location includes a configured first codepoint location, of the consecutive codepoints, that is assigned to the UE as a start of the indication of the at least one grouping of serving cells on which the UE is to monitor PDCCH. The operations of 1420 may be performed in accordance with examples as disclosed herein. In some examples, aspects of the operations of 1420 may be performed by a configuration receiving component 1025 as described with reference to FIG. 10.

At 1425, the method may include decoding each of the consecutive codepoints, beginning at the configured first codepoint location, to identify the at least one grouping of serving cells on which the UE is to monitor PDCCH. The operations of 1425 may be performed in accordance with examples as disclosed herein. In some examples, aspects of the operations of 1425 may be performed by a codepoint decoding component 1050 as described with reference to FIG. 10.

At 1430, the method may include monitoring, using a second radio of the UE and based on receiving the LP-WUS, the PDCCH on one or more serving cells of the at least one grouping of serving cells. The operations of 1430 may be performed in accordance with examples as disclosed herein. In some examples, aspects of the operations of 1430 may be performed by a PDCCH monitoring component 1035 as described with reference to FIG. 10.

The following provides an overview of aspects of the present disclosure:

Aspect 1: A method for wireless communications by a UE, comprising: receiving first control information indicating a carrier aggregation configuration associated with a plurality of serving cells for the UE; receiving second control information indicating one or more groupings of serving cells configured for the UE, wherein each grouping of serving cells of the one or more groupings of serving cells comprises a set of serving cells from among the plurality of serving cells; receiving, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor PDCCH; and monitoring, using a second radio of the UE and based at least in part on receiving the LP-WUS, the PDCCH on one or more serving cells of the at least one grouping of serving cells.

Aspect 2: The method of aspect 1, wherein receiving the LP-WUS that includes the indication of the at least one grouping of serving cells comprises: receiving the LP-WUS that includes one or more codepoints comprising the indication of the at least one grouping of serving cells.

Aspect 3: The method of aspect 2, further comprising: receiving third control information indicating the configured location and a quantity of consecutive codepoints assigned to the UE, wherein the configured location comprises a configured first codepoint location, of the consecutive codepoints, that is assigned to the UE as a start of the indication of the at least one grouping of serving cells on which the UE is to monitor PDCCH, and decoding each of the consecutive codepoints, beginning at the configured first codepoint location, to identify the at least one grouping of serving cells on which the UE is to monitor PDCCH.

Aspect 4: The method of aspect 3, wherein each codepoint of the consecutive codepoints comprises a codepoint value that is associated with a respective grouping of serving cells of the at least one grouping of serving cells on which the UE is to monitor PDCCH.

Aspect 5: The method of any of aspects 2 through 4, further comprising: receiving third control information indicating the configured location and a plurality of consecutive monitoring occasions, during the first LP-WUS occasion, for receiving a plurality of respective LP-WUSs, wherein the configured location comprises a configured first monitoring occasion location, of the plurality of consecutive monitoring occasions, that is assigned to the UE as comprising the indication of the at least one grouping of serving cells on which the UE is to monitor PDCCH, wherein receiving the LP-WUS comprises receiving, during a first monitoring occasion of the plurality of consecutive monitoring occasions, a first LP-WUS that comprises a first codepoint, located at the configured first monitoring occasion location, comprising an indication of a first grouping of serving cells of the at least one grouping of serving cells, and wherein the method further comprises decoding the first codepoint to identify the first grouping of serving cells on which the UE is to monitor PDCCH.

Aspect 6: The method of aspect 5, further comprising: receiving, during a second monitoring occasion of the plurality of consecutive monitoring occasions, a second LP-WUS that comprises a second codepoint, comprising an indication of a second grouping of serving cells of the at least one grouping of serving cells; and decoding the second codepoint to identify the second grouping of serving cells on which the UE is to monitor PDCCH.

Aspect 7: The method of any of aspects 1 through 6, wherein receiving the LP-WUS that includes the indication of the at least one grouping of serving cells comprises: receiving the LP-WUS that includes a bitmap comprising the indication of the at least one grouping of serving cells.

Aspect 8: The method of aspect 7, further comprising: receiving third control information indicating the configured location, wherein the configured location comprises a configured first bit location, within the bitmap, that is assigned to the UE as a start of the indication of the at least one grouping of serving cells on which the UE is to monitor PDCCH, and decoding the bitmap, beginning at the configured first bit location, to identify the at least one grouping of serving cells on which the UE is to monitor PDCCH.

Aspect 9: The method of aspect 8, wherein a quantity of consecutive bits of the bitmap, beginning at the configured first bit location, is assigned to the UE, the quantity of consecutive bits is equal to a quantity of the one or more groupings of serving cells configured for the UE, each bit of the consecutive bits is associated with a respective grouping of serving cells of the one or more groupings of serving cells configured for the UE.

Aspect 10: The method of any of aspects 8 and 9, wherein the LP-WUS is shared among a plurality of UEs, and different first bit locations, within the bitmap, are assigned to each of the plurality of UEs.

Aspect 11: The method of any of aspects 1 through 10, further comprising: transmitting a message indicating a UE capability to support LP-WUS triggered PDCCH monitoring of indicated groupings of serving cells.

Aspect 12: The method of any of aspects 1 through 11, wherein each grouping of serving cells comprises one or more secondary cells (SCells), a primary cell (PCell), or a combination thereof.

Aspect 13: The method of any of aspects 1 through 12, wherein the first radio comprises a low power-wakeup radio (LP-WUR) and the second radio comprises a main radio (MR).

Aspect 14: A UE for wireless communications, comprising one or more memories storing processor-executable code, and one or more processors coupled with the one or more memories and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control information indicating a carrier aggregation configuration associated with a plurality of serving cells for the UE;
receive second control information indicating one or more groupings of serving cells configured for the UE, wherein each grouping of serving cells of the one or more groupings of serving cells comprises a set of serving cells from among the plurality of serving cells;
receive, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor physical downlink control channel (PDCCH); and
monitor, using a second radio of the UE and based at least in part on receiving the LP-WUS, the PDCCH on one or more serving cells of the at least one grouping of serving cells.

2. The UE of claim 1, wherein, to receive the LP-WUS that includes the indication of the at least one grouping of serving cells, the one or more processors are individually or collectively operable to execute the code to cause the UE to:
receive the LP-WUS that includes one or more codepoints comprising the indication of the at least one grouping of serving cells.

3. The UE of claim 2, wherein the one or more processors are individually or collectively further operable to execute the code to cause the UE to:
receive third control information indicating the configured location and a quantity of consecutive codepoints assigned to the UE, wherein the configured location comprises a configured first codepoint location, of the consecutive codepoints, that is assigned to the UE as a start of the indication of the at least one grouping of serving cells on which the UE is to monitor PDCCH, and
decode each of the consecutive codepoints, beginning at the configured first codepoint location, to identify the at least one grouping of serving cells on which the UE is to monitor PDCCH.

4. The UE of claim 3, wherein each codepoint of the consecutive codepoints comprises a codepoint value that is associated with a respective grouping of serving cells of the at least one grouping of serving cells on which the UE is to monitor PDCCH.

5. The UE of claim 2, wherein the one or more processors are individually or collectively further operable to execute the code to cause the UE to:
receive third control information indicating the configured location and a plurality of consecutive monitoring occasions, during the first LP-WUS occasion, for receiving a plurality of respective LP-WUSs,
wherein the configured location comprises a configured first monitoring occasion location, of the plurality of consecutive monitoring occasions, that is assigned to the UE as comprising the indication of the at least one grouping of serving cells on which the UE is to monitor PDCCH,
wherein receiving the LP-WUS comprises receiving, during a first monitoring occasion of the plurality of consecutive monitoring occasions, a first LP-WUS that comprises a first codepoint, located at the configured first monitoring occasion location, comprising an indication of a first grouping of serving cells of the at least one grouping of serving cells, and
wherein the one or more processors are individually or collectively further operable to execute the code to cause the UE to decode the first codepoint to identify the first grouping of serving cells on which the UE is to monitor PDCCH.

6. The UE of claim 5, wherein the one or more processors are individually or collectively further operable to execute the code to cause the UE to:
receive, during a second monitoring occasion of the plurality of consecutive monitoring occasions, a second LP-WUS that comprises a second codepoint, comprising an indication of a second grouping of serving cells of the at least one grouping of serving cells; and
decode the second codepoint to identify the second grouping of serving cells on which the UE is to monitor PDCCH.

7. The UE of claim 1, wherein, to receive the LP-WUS that includes the indication of the at least one grouping of serving cells, the one or more processors are individually or collectively operable to execute the code to cause the UE to:
receive the LP-WUS that includes a bitmap comprising the indication of the at least one grouping of serving cells.

8. The UE of claim 7, wherein the one or more processors are individually or collectively further operable to execute the code to cause the UE to:
receive third control information indicating the configured location, wherein the configured location comprises a configured first bit location, within the bitmap, that is assigned to the UE as a start of the indication of the at least one grouping of serving cells on which the UE is to monitor PDCCH, and
decode the bitmap, beginning at the configured first bit location, to identify the at least one grouping of serving cells on which the UE is to monitor PDCCH.

9. The UE of claim 8, wherein:
a quantity of consecutive bits of the bitmap, beginning at the configured first bit location, is assigned to the UE,
the quantity of consecutive bits is equal to a quantity of the one or more groupings of serving cells configured for the UE, and
each bit of the consecutive bits is associated with a respective grouping of serving cells of the one or more groupings of serving cells configured for the UE.

10. The UE of claim 8, wherein:
the LP-WUS is shared among a plurality of UEs, and
different first bit locations, within the bitmap, are assigned to each of the plurality of UEs.

11. The UE of claim 1, wherein the one or more processors are individually or collectively further operable to execute the code to cause the UE to:
transmit a message indicating a UE capability to support LP-WUS triggered PDCCH monitoring of indicated groupings of serving cells.

12. The UE of claim 1, wherein each grouping of serving cells comprises one or more secondary cells (SCells), a primary cell (PCell), or a combination thereof.

13. The UE of claim 1, wherein the first radio comprises a low power-wakeup radio (LP-WUR) and the second radio comprises a main radio (MR).

14. A method for wireless communications by a user equipment (UE), comprising:
receiving first control information indicating a carrier aggregation configuration associated with a plurality of serving cells for the UE;
receiving second control information indicating one or more groupings of serving cells configured for the UE, wherein each grouping of serving cells of the one or more groupings of serving cells comprises a set of serving cells from among the plurality of serving cells;
receiving, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor physical downlink control channel (PDCCH); and
monitoring, using a second radio of the UE and based at least in part on receiving the LP-WUS, the PDCCH on one or more serving cells of the at least one grouping of serving cells.

15. The method of claim 14, wherein receiving the LP-WUS that includes the indication of the at least one grouping of serving cells comprises:
receiving the LP-WUS that includes one or more codepoints comprising the indication of the at least one grouping of serving cells.

16. The method of claim 14, wherein receiving the LP-WUS that includes the indication of the at least one grouping of serving cells comprises:
receiving the LP-WUS that includes a bitmap comprising the indication of the at least one grouping of serving cells.

17. The method of claim 16, further comprising:
receiving third control information indicating the configured location, wherein the configured location comprises a configured first bit location, within the bitmap, that is assigned to the UE as a start of the indication of the at least one grouping of serving cells on which the UE is to monitor PDCCH, and
decoding the bitmap, beginning at the configured first bit location, to identify the at least one grouping of serving cells on which the UE is to monitor PDCCH.

18. The method of claim 17, wherein:
a quantity of consecutive bits of the bitmap, beginning at the configured first bit location, is assigned to the UE,
the quantity of consecutive bits is equal to a quantity of the one or more groupings of serving cells configured for the UE, and
each bit of the consecutive bits is associated with a respective grouping of serving cells of the one or more groupings of serving cells configured for the UE.

19. The method of claim 17, wherein:
the LP-WUS is shared among a plurality of UEs, and
different first bit locations, within the bitmap, are assigned to each of the plurality of UEs.

20. A non-transitory computer-readable medium storing code for wireless communications, the code comprising instructions executable by one or more processors of a user equipment (UE) to:
receive first control information indicating a carrier aggregation configuration associated with a plurality of serving cells for the UE;
receive second control information indicating one or more groupings of serving cells configured for the UE, wherein each grouping of serving cells of the one or more groupings of serving cells comprises a set of serving cells from among the plurality of serving cells;
receive, via a first radio of the UE and during a first low power-wakeup signal (LP-WUS) occasion, an LP-WUS that includes, at a configured location for the UE within the LP-WUS, an indication of at least one grouping of serving cells, of the one or more groupings of serving cells, on which the UE is to monitor physical downlink control channel (PDCCH); and
monitor, using a second radio of the UE and based at least in part on receiving the LP-WUS, the PDCCH on one or more serving cells of the at least one grouping of serving cells.
